(19) United States
(12) Patent Application Publication
(10) Pub. No.: US 2017/0229793 A1
(43) Pub. Date: Aug. 10, 2017

(54) CRIMP CONTACT

(71) Applicant: HARTING Electric GmbH & Co. KG, Espelkamp (DE)

(72) Inventors: Martin Schmidt, Luebbecke (DE); Xiafu Wang, Dresden (DE)

(21) Appl. No.: 15/504,270

(22) PCT Filed: Aug. 5, 2015
(86) PCT No.: PCT/DE2015/100330

§ 371 Date: Feb. 15, 2017

(30) Foreign Application Priority Data
Sep. 3, 2014 (DE) 10 2014 112 701.3

(51) Int. Cl. H01R 4/50; H01R 4/62; H01R 43/048; H01R 4/20

(52) U.S. Cl. CPC H01R 4/5033; H01R 4/206; H01R 4/625; H01R 43/048

(57) ABSTRACT

This disclosure addresses the problem of aluminum and in particular stranded aluminum wires, which generally do not well bond to other metals such as e.g. copper or brass. In the long term, transition resistance changes, in particular under the influence of oxygen and due to the energizing with high currents. There is also a need for high-current connectors that can be flexibly strapped and field-wired. This disclosure provides a heavy-duty plug-type connector having at least one crimp contact, the transition between a crimping region formed of aluminum and a contact region formed of copper being shifted to the cylindrical or at least rotationally symmetric crimp contact. The stranded wire can thus be crimped with the crimp contact without the aforementioned problems. Furthermore, an additional inner thread and a pin that the can screwed into it are provided in the crimping region.

The invention relates in a first aspect to a heavy load plug connector as claimed in the preamble of the independent main claim 1.

The invention relates in a second aspect to a method for producing a crimp contact as claimed in the preamble of the independent coordinate claim 9.

The invention relates in a third aspect to a method for using a crimp contact as claimed in the preamble of the independent coordinate claim 14.

Plug connectors and contacts of this type are used in order to transfer between electrical conductors an electrical current having current strengths of by way of example 500 to 650 A.

### PRIOR ART

It is known from the prior art to use both copper wires as well as aluminum wires so as to transfer electrical energy in particular in the high current range. By way of example, at that time in the GDR era aluminum was predominantly used for this purpose as an available raw material. This most often occurred in the form of relatively rigid individual conductors so that even nowadays energy supply conductors of this type are found in the new federal states. Conversely, in the old federal states in the past stranded conductors that are embodied from copper were predominantly used.

Owing to the current prices of copper and the resources of copper that are only available in limited supply and furthermore also owing to the clearly reduced specific weight (AL: 2.73 Kg/dm³; CU: 8.9 Kg/dm³) in many areas nowadays aluminum is increasingly used in many fields as a material for electrical high current transfer lines. It is preferred that the more flexible, in other words less rigid, stranded conductors are used. The current transfer can occur both above ground for example in wind power installations and also in the railway industry but also in the case of below ground energy distribution for example in the form of ground cables as a component of a larger current distribution network. The somewhat lower specific conductivity value of aluminum and the accordingly larger cable cross section that is required as a result of using said aluminum are accepted so as to achieve the above mentioned advantages.

The increasing use of aluminum cables in wind power installations is mentioned in the publication WO 2013 174 581 A1. Furthermore, the use of electrical connectors for electrically connecting various cables is described. The use of crimp connectors and screw connectors is mentioned. In order to avoid the disadvantages as a result of oxidation at the transition of the aluminum stranded wires to the connecting piece, it is proposed to weld the cable to the connecting surfaces of the connecting piece, for example by means of friction welding.

Furthermore, it is mentioned that the connection between the aluminum cable and the connecting piece can be performed by means of friction welding, rotational friction welding, ultrasonic welding or resistance welding. The connecting piece can be embodied from copper. In an alternative thereto, it is disclosed that the connecting piece is likewise embodied from aluminum in order to avoid transition resistances or contact corrosion at the transitions between the aluminum cable and the contact piece. Moreover, a tin plating or a tin plating and nickel plating of the surface of the connecting pieces is proposed.

The publication DE 10 2013 105 669 A1 likewise discloses connecting electrical connectors to a stranded conductor by means of resistance welding.

The publication EP 1 032 077 A2 proposes in this context connecting a stranded conductor of aluminum by means of frictional welding to a contact part that is embodied from copper.

The publication EP 2 621 022 A1 discloses a cable lug for connecting a current-conducting element to an aluminum cable, wherein a first section of an associated pipe comprises on an inner face an aluminum coating and on an outer face a copper coating.

EP 2 662 934 A2 proposes the use of a connecting cap embodied from aluminum or from an aluminum alloy. This connecting cap is pressed onto the aluminum conductor and is welded to the contact part that is embodied from copper or a copper alloy.

Fundamentally, it is unfortunately particularly complex to assemble these construction forms in which in other words the stranded conductor is directly or indirectly welded onto the contact and the assembly procedure cannot be implemented on-site without corresponding devices so that it is not possible to assemble these construction forms in the field.

DE 11 2011 103 392 T5 discloses a crimp connection that is embodied from two different metal materials, for example copper and aluminum. The connecting region of these two materials is covered with a synthetic material molded part so as to avoid corrosion.

The publication EP 2 579 390 A1 likewise discloses an aluminum-copper terminal that comprises an aluminum contact part and a copper connecting part that are welded to one another, wherein the connecting region is protected by means of attaching a primary seal that is protected against electrical corrosion for example by means of injection molding using a specific thermoplastic, wherein the stranded wire is welded to the contacting part.

Consequently, in both these two latter mentioned publications, it is proposed to seal the affected transition region using a sealing arrangement, by way of example by means of injection molding using a specific thermoplastic. However, on the one hand this procedure is complex, and on the other hand such a sealing arrangement generally only has a limited serviceable life. A connector that is embodied in this manner is not suitable as a contact element for a plug connector.

The above-mentioned publications furthermore relate to connectors with which a supply cable is permanently connected to a current rail or to another cable so as to provide a fixed installation. This installation is in other words assembled once and is fundamentally not provided for the purpose of being altered numerous times.

In contrast to this, in the prior art electrical heavy load plug connectors that comprise crimp contacts are also disclosed by way of example in the publication EP 892 462 B1 and their cable connecting technology is as a consequence considerably simpler.

However, even in this case the problem remains that the stranded wires of the aluminum conductor owing to their oxidization comprise a poor so-called “cross-conductivity” (in other words the conductivity between the individual stranded wires perpendicular to the extent of the cable), which likewise increases the transition resistance to the connector contact in the case of all the described arrangements.

Furthermore, there is the further problem that aluminum oxidizes easily and furthermore connects poorly to other metals such as for example copper or brass. In particular, this applies owing to its large surface for aluminum stranded conductors. In the transition region between aluminum and by way of example copper, so-called “electrical corrosion” occurs in particular in the event of being energized with high current strengths for a long period of time and in the event of a simultaneous influence of oxygen and thereby a layer that comprises a fundamentally higher specific resistance than each of the metals involved is produced. As a result of this high resistance, an intense heating can occur during operation owing to the high current strengths and as a result of said heating this transition resistance additionally increases in the form of an interaction. This development of heat can additionally lead to further consequential damage, by way of example to a synthetic material insulation.

By way of example in the railway industry but also in many other industries, there are applications that require frequent alteration of the electrical high current cabling. Consequently, there exists in the prior art a requirement for high current connectors that can be arranged in a flexible manner and that can preferably be assembled in the field or at least can be assembled with as little outlay as possible.

### OBJECT OF THE INVENTION

The object of the invention consequently resides in providing an electrical connector that on the one hand renders it possible to connect an aluminum stranded conductor in a comparatively simple manner and that on the other hand renders possible as flexible an arrangement as possible and that furthermore even in the case of a high current strength acting over a long period of time comprises a sustainably good electrical conductivity.

The object of the invention is achieved in a first aspect with a heavy load plug connector of the type mentioned in the introduction by virtue of the features of the characterizing part of the independent main claim 1.

In a second aspect, the object is achieved using a method of production of the type mentioned in the introduction by virtue of the features of the characterizing part of the independent coordinate claim 9.

In a third aspect, the object is achieved with a method of application of the type mentioned in the introduction by virtue of the features of the characterizing part of the independent coordinate claim 14.

Advantageous embodiments of the invention are disclosed in the dependent claims.

The invention in accordance with the first aspect is a heavy load plug connector having at least one crimp contact, wherein the crimp contact comprises a crimp region that is embodied from aluminum or an aluminum alloy, and a contact region that adjoins said crimp region and is embodied from copper or from a copper alloy, wherein the contact region can be embodied as a pin-shaped or socket-shaped manner. Consequently, an aluminum stranded conductor having a crimp region can be crimped without a so-called “electrical corrosion” consequently occurring.

The transition from copper material to the aluminum material is relocated for this purpose in accordance with the invention in the crimp contact. This is rendered possible in that the crimp region is welded to the contact region. In particular, this connection is produced when producing the crimp contact by means of a frictional welding procedure.

The crimp contact can in other words be a contact pin that is capable of conducting high currents or a contact socket that is capable of conducting high currents. At least one contact pin of this type and/or one contact socket are inserted into an insulating body and together with said insulating body form a component of the heavy load plug connector.

It is particularly advantageous that the crimp contact is at least in regions embodied in a rotationally symmetrical manner or comprises at least one or multiple regions having a cylindrical shape or at least a rotationally symmetrical outer contour because said crimp contact can consequently be arranged in a positive-locking manner in the through-going holes or corresponding likewise rotationally symmetrical through-going openings of the insulating body.

Furthermore, it is advantageous in accordance with the second aspect during production to use aluminum owing to its ability to deform easily as a material for the crimp region of the crimp contact. This is particularly advantageous for crimping an aluminum conductor, in particular an aluminum stranded conductor because electrical corrosion and in intermetallic phase does not occur on the affected region despite unavoidable contact with oxygen.

The crimp region comprises a hollow chamber having a cable insertion opening for receiving the aluminum stranded conductor.

Furthermore, an additional through-going hole can be subsequently drilled in the crimp contact to the hollow chamber and an inner thread can be cut in said through-going opening.

In accordance with the third aspect of the invention, it is possible by way of said inner thread for a spike, which comprises an outer thread that is tailored to suit said inner thread, and also a tip that is connected to said outer thread to be screwed using its tip forwards into the hollow chamber, preferably in the direction of the cable insertion opening, in other words counter to the direction of insertion of the stranded conductor.

As a consequence, the stranded wires of the previously inserted aluminum stranded conductor are pressed from the interior against the crimp region. Advantageously, the crimp contact comprises an additional inner thread within its crimp region. The stranded conductor is then pressed from the interior against said additional inner thread, wherein the additional inner thread holds the stranded wires by means of the increased frictional force. Furthermore, the oxide layer of the aluminum stranded wires is broken open. As a consequence and by means of the pressure against one another, the cross conductivity of the stranded conductor increases. Consequently, the transition resistance between the stranded conductor and the crimp contact decreases. The conductivity is also sustainably increased after crimping by means of using the spike, in particular if the spike is preferably embodied from aluminum or also from another electrically conductive material, by way of example a copper alloy and as a consequence the contact surface of the crimp contact increases with respect to the stranded conductor.

During production, it is advantageous if the inner radius of the cylindrical hollow chamber is greater than the theoretical inner radius of the additional inner thread that is cut so that the additional inner thread that protrudes into the hollow chamber is flattened off. This is particularly advantageous because as a consequence on the one hand two desired effects of the additional thread remain intact, namely 1.) that the oxide layer of the aluminum stranded wires is broken open, and 2.) that the stranded conductor is held in the hollow chamber using a particularly effective frictional effect against the direction of insertion, but that on the other hand 3.) the stranded wires are not damaged. Thirdly, it is particularly advantageous if the actual depth of the thread that has been flattened off is smaller than the diameter of the stranded wires so that the thread cannot cut through said stranded wires.

Owing to its stability and good electrical conductivity it is advantageous to use copper as a material for the contact region. In one advantageous embodiment, the contact region is additionally coated at least in part, by way of example silver-plated or gold-plated, and thus permanently protected against corrosion. Furthermore, as a consequence a permanent low ohmic plug connection to other copper contacts and furthermore to corresponding copper conductors is advantageously also possible since the problematic transition between copper and aluminum is relocated in accordance with the invention into the interior of the crimp contact.

It is particularly advantageous that the crimp region that is embodied from aluminum is connected to the contact region that is embodied from copper by means of frictional welding because in this manner electrical corrosion is prevented from occurring. Finally, the contact surface is thus located in the interior of the contact and in this manner does not come into contact with oxygen. As a consequence, a good conductivity is also sustainable, in other words is also ensured over a long period of time.

Furthermore, the welding procedure in particular the frictional welding provides a particularly stable connection so that the crimp contact is also mechanically stable.

During production, in accordance with the second aspect of the invention it is possible to use cylindrical copper and aluminum blanks that are welded to one another in the axial direction, in particular by means of frictional welding. Initially, the rotational welding appears accordingly expedient for the frictional welding procedure. However, it is also advantageously possible to connect the crimp region to the contact region by means of vibration welding. In practice, a combination of rotational welding and vibration welding has proven particularly advantageous since in the case of pure rotational welding there is the disadvantage that the inner regions of the contact surface experience less friction than the outer regions so that the elements have had to comprise at least in the contact region a central so-called “blind hole”. However, during a particularly complex vibration welding procedure all regions experience the same frictional energy so that even the inner regions of the contact surface can be welded. In combination, the advantages of the two methods can expediently complement one another.

The contact region can be embodied as a pin contact or socket contact by means of a turning and drilling procedure and the hollow chamber can be drilled with the cable insertion opening into the crimp region. It is preferred that the additional inner thread that is used to increase the frictional force acting upon the stranded conductor can be cut in the hollow chamber.

### EXEMPLARY EMBODIMENT

An exemplary embodiment of the invention is illustrated in the drawings and is further explained hereinunder.

In the drawings:

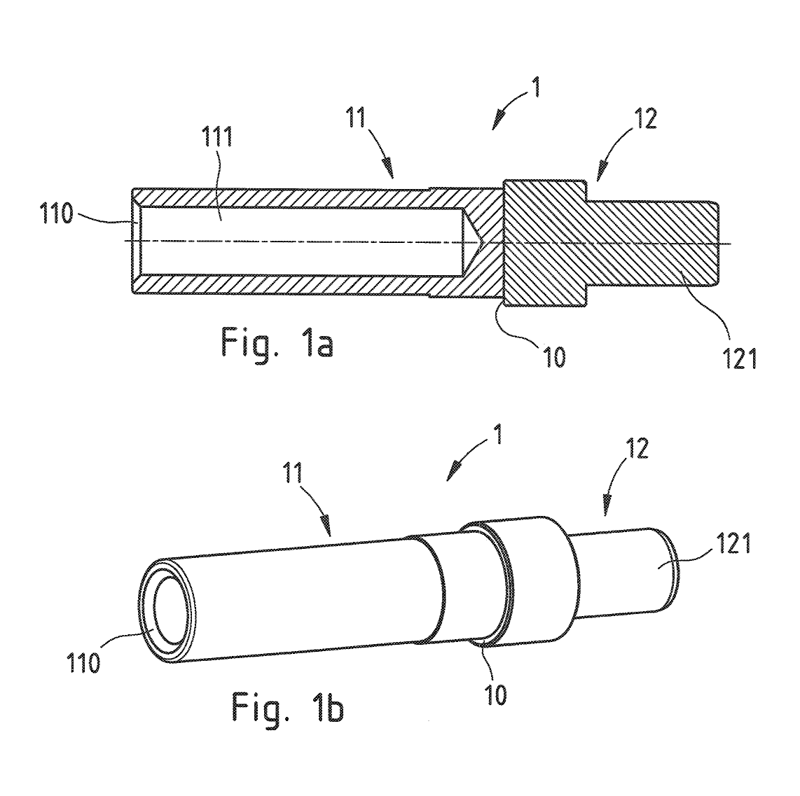

FIGS. 1a,b illustrate a cross sectional view and a perspective view of a crimp contact that is embodied as a pin contact,

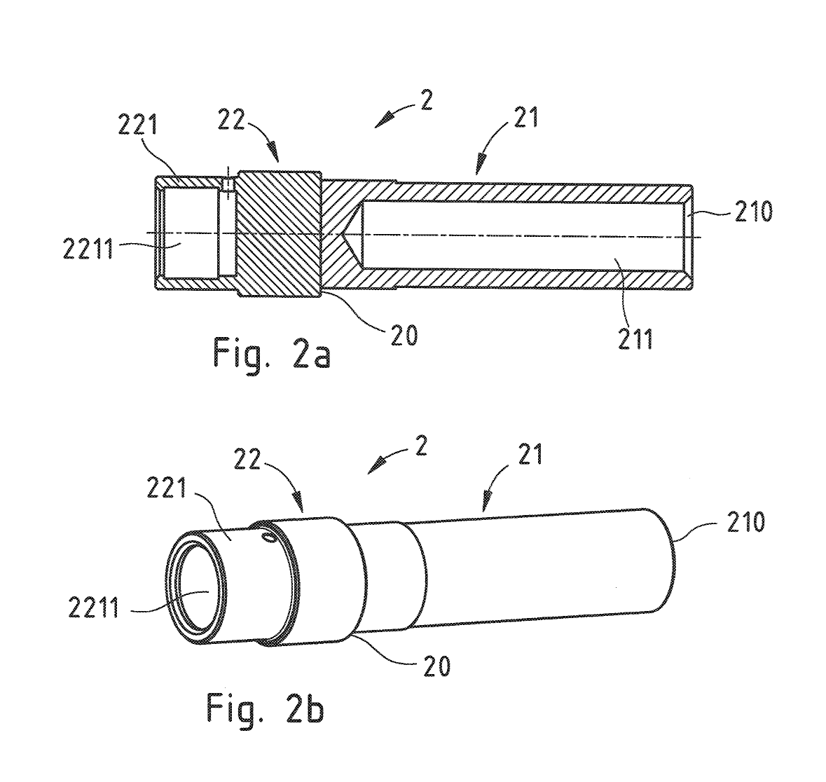

FIGS. 2a,b illustrate a cross sectional view and a perspective view of a crimp contact that is embodied as a socket contact,

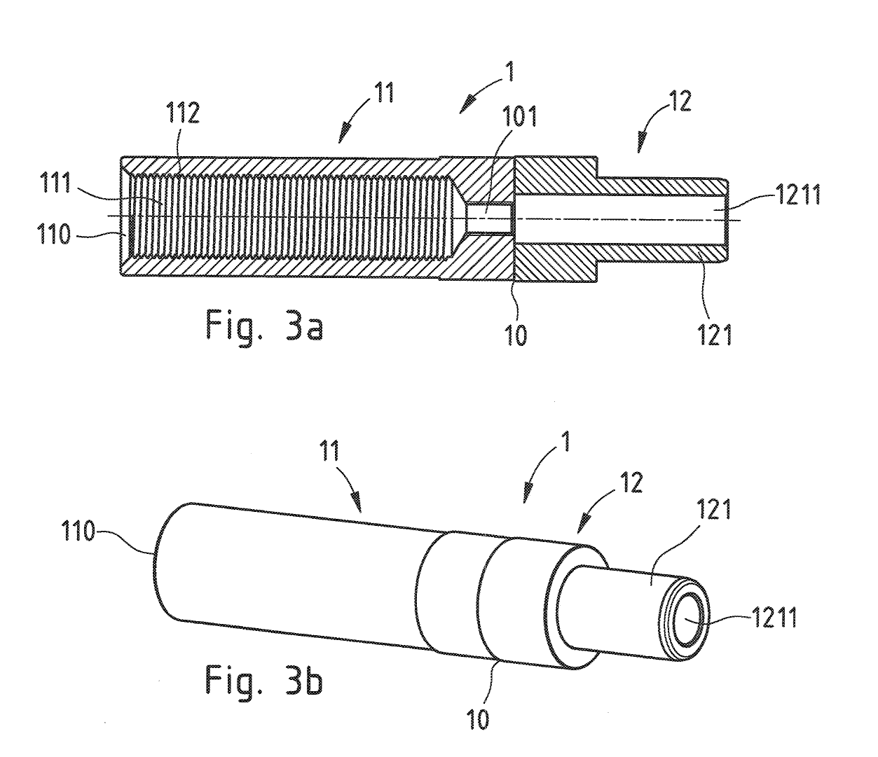

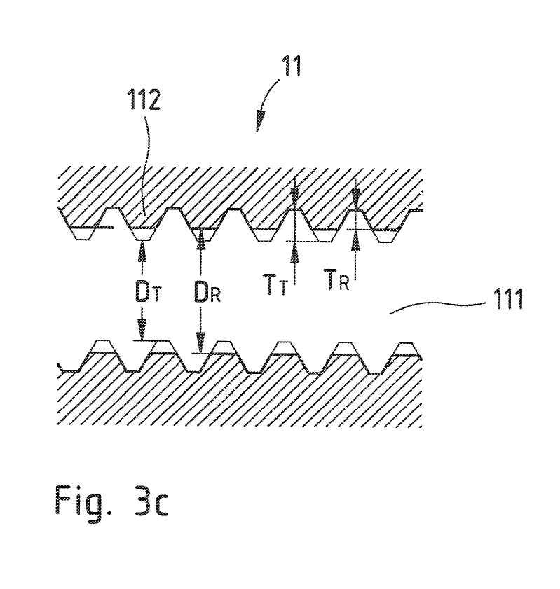

FIGS. 3a,b illustrate a cross sectional view and a perspective view of the pin contact having an inner thread,

FIG. 3c illustrates an enlarged view of the inner thread,

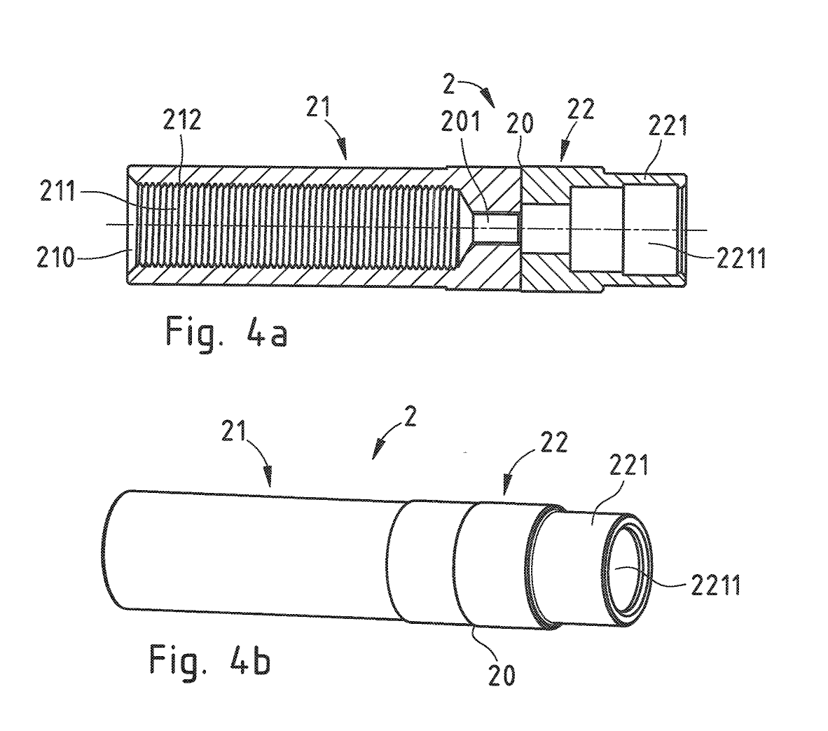

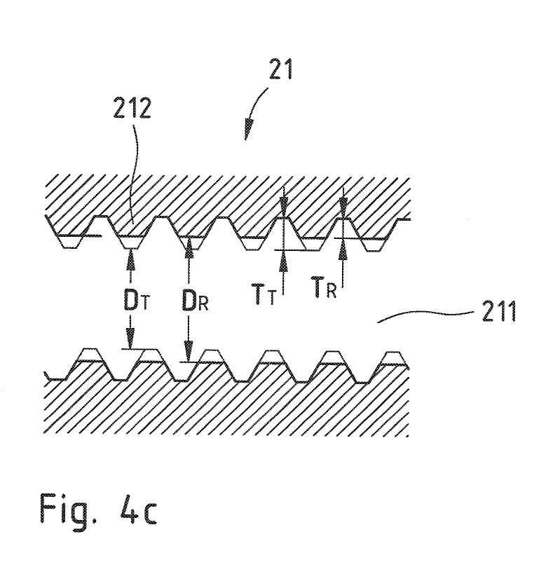

FIGS. 4a,b illustrate a cross sectional view and a perspective view of the socket contact having an inner thread,

FIG. 4c illustrates an enlarged view of the inner thread,

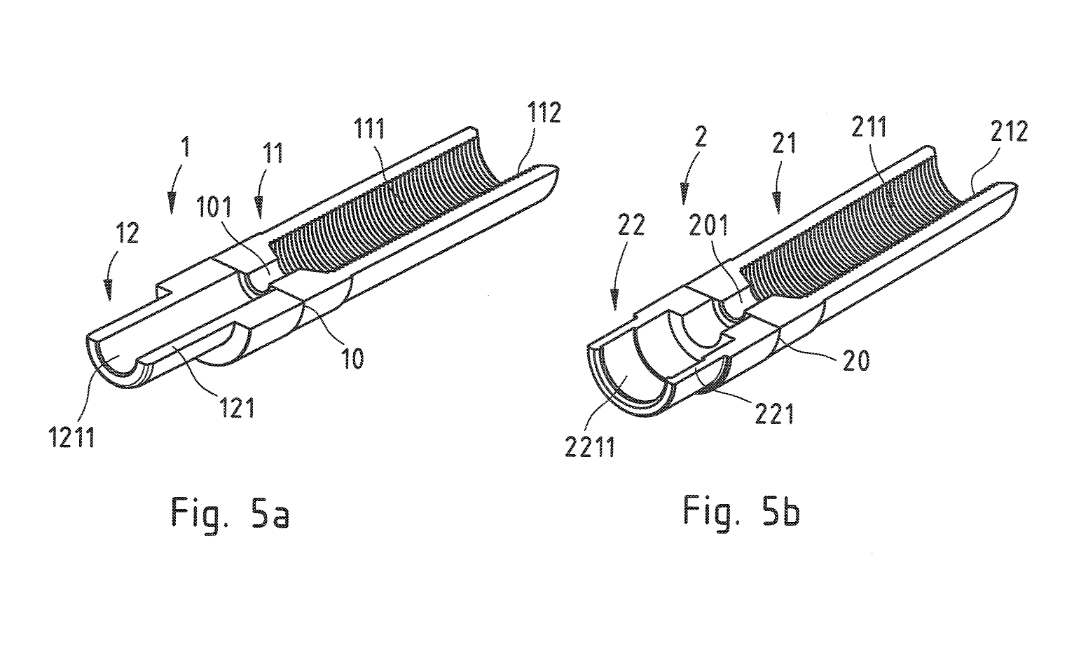

FIGS. 5a,b illustrate a 3D cross sectional view of the pin contact and socket contact having the additional inner thread,

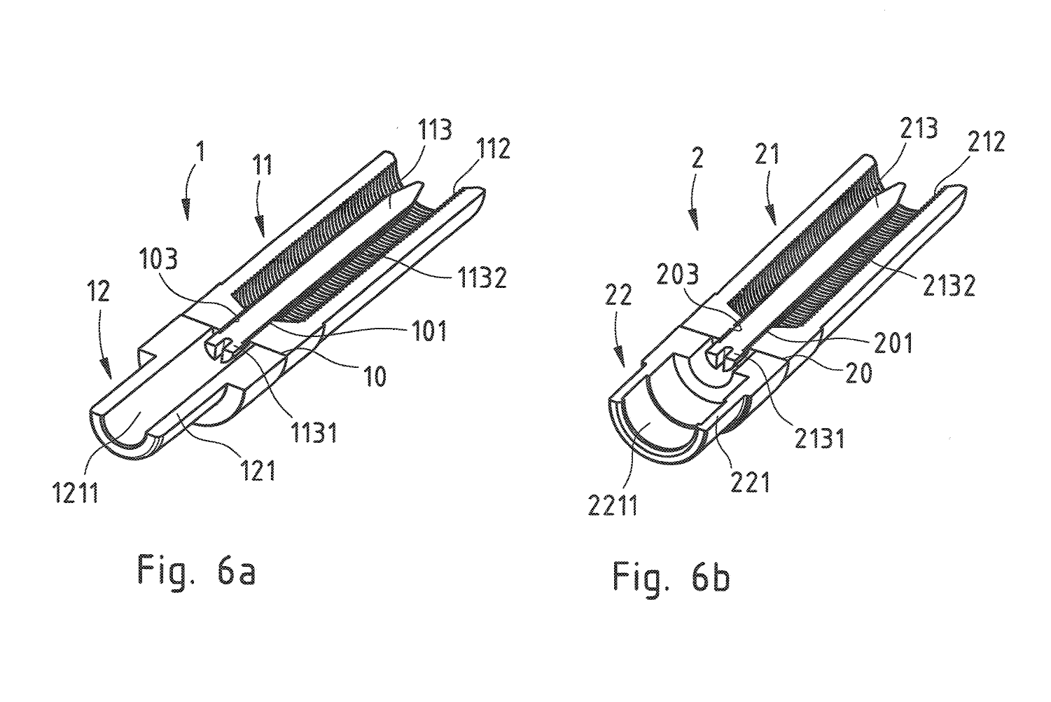

FIGS. 6a,b illustrate a 3D cross sectional view of the pin contact and socket contact having the additional inner thread and a spike,

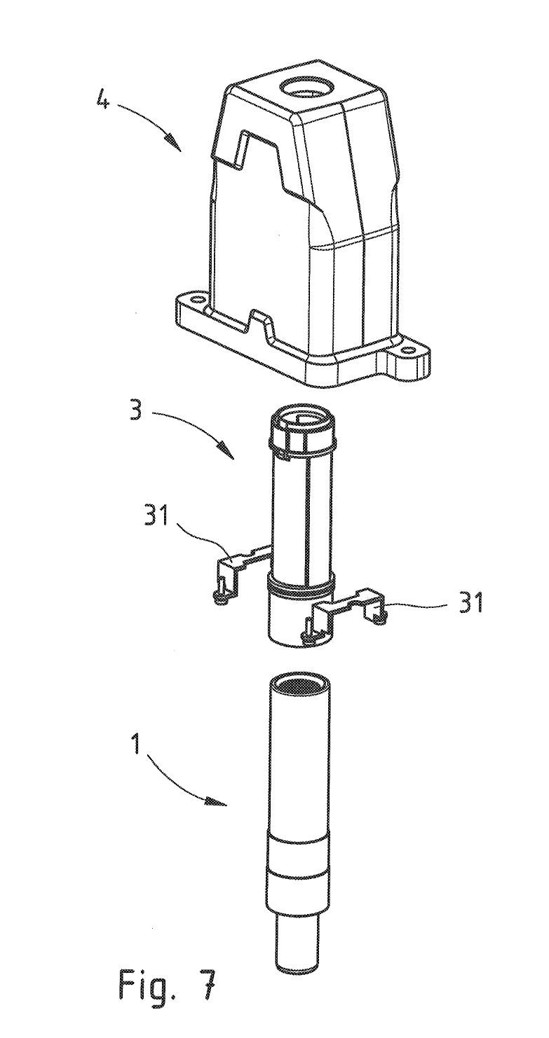

FIG. 7 illustrates a heavy load plug connector in an exploded view.

The figures include in part simplified, schematic illustrations. In part, identical reference numerals are used for identical but however where appropriate non-identical elements. Various views of identical elements could be scaled differently.

FIG. 1a illustrates a cross sectional view and FIG. 1b illustrates a perspective view of a first crimp contact that is embodied as a pin contact 1. The pin contact 1 comprises a first crimp region 11 and a first contact region 12 that are in contact with one another at a first transition region 10, by way of example in that said crimp region and contact region are welded to one another, in particular by means of a frictional welding procedure. For this purpose, during production by way of example two cylindrical blanks, of which one is embodied from copper and the other from aluminum, are attached to one another in the axial direction and are welded to one another for example by means of rotational welding and/or vibration welding. In the subsequent working steps, the first contact region 12 that is embodied from copper can be provided with a contact pin 121 by means of a turning and drilling procedure so that this crimp contact is a pin contact 1.

It is possible to drill a first hollow chamber 111 into the first crimp region 11 that is embodied from aluminum. As a consequence, the first crimp region 11 comprises on its free-standing end adjacent to the hollow chamber a first cable insertion opening 110.

FIG. 2a illustrates a cross sectional view and FIG. 2b illustrates a perspective view of a second crimp contact that is embodied as a socket contact 2. The socket contact 2 comprises a second crimp region 21 and a second contact region 22 that are in contact with one another on a second transition region 20, by way of example in that said second crimp region and second contact region are welded to one another, in particular by means of a frictional welding procedure. For this purpose, during production by way of example two cylindrical blanks, of which one is embodied from copper and the other from aluminum are attached to one another in the axial direction and are welded to one another, for example by means of rotational welding and/or vibration welding. In the subsequent working steps the second contact region 22 that is embodied from copper can be provided with a contact socket 221 by means of a turning and drilling procedure so that this crimp contact is a socket contact 2. Naturally, the socket 221 comprises a socket hollow chamber 2211 that is likewise preferably produced by means of a drilling procedure.

A hollow chamber 211 can furthermore be drilled into the second crimp region 21 that is embodied from aluminum. As a consequence, the second crimp region 21 comprises a second cable insertion opening 210 on its free-standing end adjoining the second hollow chamber 211.

FIG. 3a and FIG. 3b illustrate in a comparable manner the pin contact 1 in a modified embodiment in which the pin contact 1 additionally comprises a first through-going opening 101 that comprises a cylindrical form in order to be able to receive a spike 113 that is not illustrated in this figure (illustrated in FIG. 6a). Furthermore, the modified pin contact 1 comprises a pin hollow chamber 1211 that is connected by way of the first cylindrical through-going opening 101 to the first hollow chamber 111. During production, the first through-going opening 101 is preferably generated by means of a drilling procedure so that the first through-going opening 101 is a through-going hole. Furthermore, it is possible to cut an inner thread 103 into the first through-going opening 101 so that the spike 113 that comprises an outer thread 2132 that is tailored to suit said inner thread can be screwed into the first through-going opening 101 and furthermore into the first hollow chamber 111.

Furthermore, the first crimp region 11 comprises in this modified embodiment in its first hollow chamber 111 a first additional inner thread 112 that is cut from the interior into the first crimp region 11 during production of the pin contact 1. This first additional inner thread 112 is used for the purpose of holding a stranded conductor, which is inserted into the first hollow chamber 111, in said chamber by means of an increased frictional force, even if the spike 113 is screwed into the first hollow chamber 111 in the direction of the first cable insertion opening 110, in other words against the direction of insertion of the stranded conductor.

FIG. 3c illustrates an advantageous embodiment of the first additional inner thread 112 in an enlarged view. It is clear that the theoretical inner diameter D_{T} of the first additional inner thread 112 is smaller than the actual inner diameter D_{R} of the first hollow chamber 111. The actual extent of this inner thread 112 is illustrated by means of the hatched area. Conversely, the non-hatched area illustrates the theoretical extent which extends over the actual extent of this inner thread 112 and which a theoretical inner thread having the theoretical thread depth T_{T} and the theoretical thread inner diameter D_{T} would have. The actual hollow chamber inner diameter D_{R} is however larger than the theoretical thread inner diameter D_{T} that is used as a measure for the inner thread that is to be cut. As a consequence, this inner thread 112 comprises an actual thread depth T_{R} that is smaller than the theoretical thread depth T_{T} and the actual extent of the thread 112 is more intensely flattened off than usual.

In other words, during production only the outer part of the theoretical inner thread is cut in the first crimp region 11 and the additional inner thread 112 that actually exists and is formed as a result consequently comprises a form that is a particularly flattened off form.

FIGS. 4a and 4b illustrate in a comparable manner the socket contact 2 that has been modified in order to be able to receive a spike 213 that is not illustrated at this stage in this figure (illustrated in FIG. 6b). For this purpose, the socket hollow chamber 2211 is connected to the second hollow chamber 211 by way of a second cylindrical through-going opening 201. During production, this second through-going opening 201 is preferably produced by means of a drilling procedure so that the second through-going opening 201 is a through-going hole. A second additional thread 203 can also be cut into the second through-going opening 201 so that the spike 213 that comprises an outer thread 2132 that is tailored to suit said inner thread can be screwed into the second through-going opening 201 and furthermore into the second hollow chamber 211.

Furthermore, the second crimp region 21 comprises in the second hollow chamber 211 a second additional inner thread 212 that is cut during production from the interior into the crimp region 21 of the socket contact 2. This second additional thread 212 is used for the purpose of holding a stranded conductor that is inserted into the second hollow chamber 211 in said hollow chamber by means of an increased frictional force even if the spike 213 is screwed into the second hollow chamber 211 in the direction of the second cable insertion opening 210, in other words against the direction of insertion of the stranded conductor.

An advantageous embodiment of the second additional inner thread 212 is illustrated in an enlarged view in FIG. 4c. The actual extent of this inner thread 212 is illustrated by means of the hatched area. Conversely, the non-hatched area illustrates the further theoretical extent that a theoretical inner thread having the theoretical thread depth T_{T} and the theoretical thread inner diameter D_{T} would have. The hollow chamber inner diameter D_{R} is accordingly larger than the theoretical thread inner diameter D_{T} that is however used as a measure for the inner thread that is to be cut. As a consequence, this inner thread 212 comprises an actual thread depth T_{R} that is smaller than the theoretical thread depth T_{T} and the actual extent of the thread 212 is more intensely flattened off than usual.

In other words, during production only the outer part of the theoretical inner thread is cut in the second crimp region 21 and the additional inner thread 212 that actually exists and is formed as a result consequently comprises a particularly flattened off form.

FIGS. 5a and 5b illustrate the pin contact 1 and the socket contact 2 having the respective cylindrical through-going opening 101, 201 in a cut 3D illustration opposite one another.

FIGS. 6a and 6b illustrate the pin contact 1 and the socket contact 2 having the respective through--going opening 101, 201 and an associated first or second spike 113, 213. Each of the through-going openings 101, 201 comprises an associated inner thread 103, 203. The respective spike 113, 213 comprises in each case an outer thread 1132, 2132 that is tailored to suit said inner thread, and said spike is screwed into the respective through-going opening 101, 201 by means of said outer thread. Furthermore, the spike 113, 213 can comprise a screw head 1131, 2131 that renders it possible to screw in the spike from the pin hollow chamber or socket hollow chamber 1211, 2211.

FIG. 7 illustrates a complete heavy load plug connector in an exploded view. A pin contact 1 is illustrated in an exemplary manner. Said heavy load plug connector could likewise easily be a socket contact 2.

Furthermore, an insulating body 3 is illustrated that is provided so as to receive the pin contact 1. This insulating body 3 can be fastened for its part by way of fastening elements 31 in the plug connector housing 4.

### LIST OF REFERENCE NUMERALS

1 Pin contact
10 First transition region
101 First through-going opening
103 Inner thread
11 First crimp region
110 First cable insertion opening
111 First hollow chamber
112 First additional inner thread
12 First contact region
121 Contact pin
1211 Pin hollow chamber
113 First spike
1131 Screw head of the first spike
1132 Outer thread of the spike
2 Socket contact
20 Second transition region
201 Second through-going opening
203 Inner thread
21 Second crimp region
210 Second cable insertion opening
211 Second hollow chamber
212 Second additional inner thread
22 Second contact region
221 Contact socket
2211 Socket hollow chamber
213 Second spike
2131 Screw head of the second spike
2132 Outer thread of the second spike
3 Insulating body
31 Fastening elements
4 Plug connector housing
D_{R} Actual inner diameter of the first/second hollow chamber
D_{T} Theoretical inner diameter of the additional inner thread
T_{R} Actual depth of the additional inner thread
T_{T} Theoretical depth of the further inner thread

1. A heavy load plug connector comprising a plug connector housing, an insulating body and at least one crimp contact that is arranged in the insulating body, wherein
the crimp contact is embodied at least in regions in a rotationally symmetrical manner, wherein the corresponding symmetrical axis extends in the plugging direction,
wherein the crimp contact comprises a crimp region that is embodied from aluminum or an aluminum alloy, and
wherein the crimp contact comprises a contact region (12, 22) that adjoins the crimp region (11, 21), said contact region being embodied from copper or a copper alloy, and that the crimp region (11, 21) is welded to the contact region (12, 22).

2. The heavy load plug connector as claimed in claim 1, wherein the crimp contact comprises in its crimp region a cylindrical hollow chamber having a cable insertion opening for receiving an aluminum stranded conductor.

3. The heavy load plug connector as claimed in claim 2, wherein the crimp contact comprises in its cylindrical hollow chamber an additional inner thread.

4. The heavy load plug connector as claimed in claim 3, wherein the actual inner diameter of the cylindrical hollow chamber is greater than the theoretical inner diameter of the additional inner thread so that the additional inner thread is flattened off.

5. The heavy load plug connector as claimed in claim 2, wherein the crimp contact comprises within its hollow chamber a spike that points in a direction of the cable insertion opening.

6. The heavy load plug connector as claimed in claim 5, wherein the spike comprises an outer thread, and that the crimp contact comprises a through-going opening having an inner thread that is tailored to said through-going opening so that the spike can be screwed by way of the through-going opening into the hollow chamber.

7. The heavy load plug connector as claimed in claim 6, wherein the spike comprises a screw head so that said spike can be screwed with the aid of a screwdriver into the hollow chamber.

8. The heavy load plug connector as claimed in claim 1, wherein the surface of the contact region is at least in part coated with silver.

9. A method for producing a crimp contact, comprising the following steps:
1) welding together a cylindrical copper rod and a cylindrical aluminum rod by frictional welding to form a common cylindrical rod having an aluminum part and a copper part,
2) producing by turning and/or drilling an aluminum part a crimp region having a hollow chamber for receiving an aluminum stranded conductor and producing a contact region from the copper part, and
3) coating the surface of the contact region at least in part with silver.

10. The method as claimed in claim 9, wherein that the frictional welding in the first method step comprises rotational welding and/or vibration welding.

11. The method as claimed in claim 9, wherein the second method step the hollow chamber is drilled with an actual inner diameter in the crimp region.

12. The method as claimed in claim 11, wherein an additional inner thread cut with a theoretical inner diameter in the crimp region on the hollow chamber side.

13. The method as claimed in claim 12, wherein the theoretical inner diameter of the additional inner thread is smaller than the actual diameter of the hollow chamber.

14. A method for using a crimp contact, wherein initially a stranded conductor is inserted through a cable insertion opening into a cylindrical hollow chamber of a crimp region of the crimp contact and wherein in a later method step the crimp region is pressed together using a crimping tool, wherein
after inserting the stranded conductor and prior to pressing together the crimp region spike is screwed into the hollow chamber of the crimp region opposite the direction of insertion of the stranded conductor.

15. The method as claimed in claim 14, wherein that the stranded conductor is held when screwing the spike by an additional inner thread of the hollow chamber using a particularly strong frictional force in the hollow chamber.

16. The method as claimed in claim 14, wherein
the stranded wires of the stranded conductor are pressed together by means of screwing in the Spike and are pressed from the interior against the crimp region, and that as a consequence furthermore oxide layers of the stranded conductors are broken open, as a result of which the cross conductivity is increased.

17. The heavy load plug connector as claimed in claim 3, wherein the crimp contact comprises within its hollow chamber a spike that points in a direction of the cable insertion opening.

18. The heavy load plug connector as claimed in claim 4, wherein the crimp contact comprises within its hollow chamber a spike that points in a direction of the cable insertion opening.

19. The heavy load plug connector as claimed in claim 7, where the screw head comprises a slot or a cross slot screw head.

20. The method as claimed in claim 15, wherein the stranded wires of the stranded conductor are pressed together by screwing in the spike and are pressed from the interior against the crimp region, and that as a consequence furthermore oxide layers of the stranded conductors are broken open, as a result of which the cross conductivity is increased.
